(19) United States
(12) Patent Application Publication
(10) Pub. No.: US 2017/0198437 A1
(43) Pub. Date: Jul. 13, 2017

(54) RESIN SHEET, ARTICLE, AND METHOD FOR MANUFACTURING RESIN SHEET

(71) Applicant: SUMITOMO BAKELITE CO., LTD., Tokyo (JP)

(72) Inventors: Ryosuke Sugino, Tokyo (JP); Yasutaka Kimura, Tokyo (JP)

(73) Assignee: SUMITOMO BAKELITE CO., LTD., Tokyo (JP)

(21) Appl. No.: 15/314,188

(22) PCT Filed: May 12, 2015
(86) PCT No.: PCT/JP2015/063557

§ 371 Date: Nov. 28, 2016

(30) Foreign Application Priority Data
May 29, 2014 (JP) 2014-111191

(51) Int. Cl. D21H 13/26; C08L 61/06; D21H 13/50; C08K 7/02; C08L 23/12; C08J 5/18; C08L 63/00

(52) U.S. Cl. CPC D21H 13/26; C08J 5/18; C08L 61/06; C08L 63/00; C08K 7/02; C08L 23/12; D21H 13/50; C08L 2205/035; C08L 2205/03; C08J 2361/10; C08J 2363/00; C08J 2323/12; C08J 2477/10; C08J 2471/02; C08J 2433/20

(57) ABSTRACT

A resin sheet includes a binder resin; a fibrous filler having a fiber length of equal to or longer than 15 mm and equal to or shorter than 100 mm; and pulp.

### TECHNICAL FIELD

The present invention relates to a resin sheet, an article, and a method for manufacturing a resin sheet.

### BACKGROUND ART

In a variety of fields such as the electrical and electronic field or the automobile industry field, there are cases in which fibrous materials are used as materials for constituting a variety of articles. Examples of the above-described technique include techniques described in Patent Documents 1 to 4.

Patent Document 1 describes a technique regarding a carbon fiber web including a carbon fiber bundle and at least one reinforcement fiber bundle. Patent Document 2 describes a technique regarding a carbon fiber composite sheet made of a carbon fiber bundle. Patent Document 3 describes a technique regarding a method for manufacturing a half-finished product which includes a thermoplastic fiber and a reinforcement fiber and is thermally transformable. Patent Document 4 describes a technique regarding a method for manufacturing a C/C composite material (carbon fiber reinforcement carbon composite material).

### RELATED DOCUMENT

### Patent Document

[Patent Document 1] Japanese Laid-open Patent Publication No. 2010-37668

[Patent Document 2] Japanese Laid-open Patent Publication No. 2013-209758

[Patent Document 3] Japanese Laid-open Patent Publication No. 2014-62336

[Patent Document 4] Japanese Laid-open Patent Publication No. 2013-87367

### SUMMARY OF THE INVENTION

In order to forma variety of articles, there are cases in which, for example, a resin sheet including a binder resin and a fibrous filler is used. In recent years, there has been a demand for improving the mechanical characteristics of layers formed of the above-described resin sheet in order to improve the reliability of the above-described articles.

According to the present invention, there is provided a resin sheet including: a binder resin; a fibrous filler having a fiber length of equal to or longer than 15 mm and equal to or shorter than 100 mm; and pulp.

According to the present invention, there is provided an article including a layer formed of the above-described resin sheet.

According to the present invention, there is provided a method for manufacturing a resin sheet including: a step of papermaking using a material composition including a binder resin, a fibrous filler having a fiber length of equal to or longer than 15 mm and equal to or shorter than 100 mm, and pulp.

According to the present invention, it is possible to improve the mechanical characteristics of layers formed of a resin sheet.

### BRIEF DESCRIPTION OF THE DRAWINGS

The above-described object, other objects, characteristics, and advantages will become clearer using preferred embodiments described below and the following drawings accompanied by the embodiments.

FIG. 1 is a cross-sectional diagram illustrating a method for manufacturing a resin sheet according to the present embodiment.

FIG. 2 is a perspective diagram illustrating an example of a resin sheet manufactured using a papermaking method.

FIG. 3 is a cross-sectional diagram illustrating an example of a resin sheet manufactured using a papermaking method.

FIG. 4 is a cross-sectional diagram illustrating a method for forming a compact using a resin sheet.

FIG. 5 is a cross-sectional diagram illustrating an example of an article according to the present embodiment.

### DESCRIPTION OF EMBODIMENTS

Hereinafter, embodiments will be described using the accompanying drawings. Furthermore, in all of the drawings, the same constitutional element will be given the same reference sign and will not be repeated.

A resin sheet according to the present embodiment includes a binder resin, a fibrous filler having a fiber length of equal to or longer than 15 mm and equal to or shorter than 100 mm, and pulp.

As described above, for resin sheets including a binder resin and a fibrous filler, there is a demand for improving the mechanical characteristics of layers formed of the resin sheets. The mechanical characteristics of the above-described layers can be evaluated on the basis of, for example, bending strength, impact resistance, and the like. As a result of intensive studies, the present inventors newly found that, when a binder resin, a fibrous filler having a fiber length of equal to or longer than 15 mm and equal to or shorter than 100 mm, and pulp are all added to a resin sheet, the mechanical characteristics of layers formed using the resin sheet are improved and completed the resin sheet according to the present embodiment. As described above, according to the present embodiment, it is possible to improve the mechanical characteristics of layers formed of a resin sheet. Therefore, it also becomes possible to contribute to improving the reliability of articles including the layer.

Hereinafter, the resin sheet according to the present embodiment and an article will be described in detail.

(Resin Sheet)

First, the resin sheet will be described.

The resin sheet is used to form, for example, layers constituting a variety of articles. Therefore, it becomes possible to realize layers having excellent balance among mechanical characteristics, thermal characteristics, electromagnetic wave-shielding performance, and the like. In the present embodiment, examples of articles including a layer formed using a resin sheet include flexible wiring substrates, interposer substrates, substrates constituting electronic components such as component-embedded substrates and optical waveguide substrates, chasses of electronic devices, and the like. Meanwhile, the use of the resin sheet is not limited to the above-described use, and the resin sheet can be applied to a variety of use, for example, electrical and electronic use, automobile use, and the like.

As described below, the resin sheet is formed using, for example, a papermaking method. The papermaking method refers to a technique for making paper which is one of paper production techniques. In the present embodiment, the resin sheet is composed of a papermaking product obtained by the papermaking method using, for example, a material composition including a binder resin, a fibrous filler, and pulp. As described above, when the papermaking method is employed, it is possible to improve the mechanical characteristics or thermal characteristics of layers formed using the resin sheet. The reason therefor is not clear, but is assumed that the fibrous filler can be uniformly dispersed in the resin sheet, fibrous filler segments can be appropriately entangled together, or the like. In addition, since the papermaking method is excellent in terms of workability, it is also possible to improve the designability of the resin sheet. In addition, the papermaking method does not limit the combination of materials constituting the resin sheet. Therefore, it is possible to appropriately use a variety of other additives in addition to a binder resin, a fibrous filler, and pulp depending on characteristics required for articles.

The resin sheet includes a binder resin (A), a fibrous filler (B), and pulp (C).

((A) Binder Resin)

The binder resin (A) is not particularly limited as long as the binder resin is capable of acting as a binder and thus binding the fibrous filler (B) and may include either or both a thermosetting resin and a thermoplastic resin. The binder resin particularly preferably includes a thermosetting resin from the viewpoint of improving the mechanical strength or chemical resistance of layers formed using the resin sheet. In addition, the binder resin particularly preferably includes a thermoplastic resin from the viewpoint of improvement in the moldability of the resin sheet or necessity of the design properties, such as transparency, of the resin.

Meanwhile, as the binder resin (A), for example, a binder resin having a solid phase at 25° C. is more preferably used from the viewpoint of the stable manufacturing of the resin sheet using the papermaking method.

As the thermosetting resin that is used as the binder resin (A), it is possible to include one or more resins selected from a phenolic resin, an epoxy resin, an unsaturated polyester resin, a melamine resin, and a polyurethane resin. Among these, at least one of a phenolic resin and an epoxy resin is more preferably included from the viewpoint of improving the balance between mechanical characteristics and thermal characteristics. As the thermoplastic resin that is used as the binder resin (A), it is possible to include one or more resins selected from an acrylonitrile-styrene copolymer (AS) resin, an acrylonitrile-butadiene-styrene copolymer (ABS) resin, polycarbonate, polystyrene, polyvinyl chloride, polyester-based resins, polyamide, a polyphenylene sulfide (PPS) resin, an acrylic resin, polyethylene, polypropylene, and fluororesin. Among these, polypropylene is more preferably included from the viewpoint of improving the balance between mechanical characteristics and thermal characteristics.

The content of the binder resin (A) is preferably equal to or higher than 10% by weight, more preferably equal to or higher than 30% by weight, and particularly preferably equal to or higher than 40% by weight of the entire resin sheet. In such a case, it is possible to more effectively improve the workability or lightweight properties of the resin sheet. On the other hand, the content of the binder resin (A) is preferably equal to or lower than 80% by weight, more preferably equal to or lower than 70% by weight, and particularly preferably equal to or lower than 65% by weight of the entire resin sheet. In such a case, it becomes possible to more effectively improve the mechanical characteristics or thermal characteristics of layers that are formed using the resin sheet.

((B) Fibrous Filler)

The fibrous filler (B) is a fibrous material capable of having a variety of shapes depending on required characteristics. In the present embodiment, as the shape of the fibrous filler (B), it is possible to employ, for example, a chopped strand, a milled fiber, a cut fiber, or the like. Therefore, it is possible to more effectively improve mechanical strength, impact resistance, thermal resistance, and the like. Meanwhile, in the present specification, the pulp (C) described below is not considered as the fibrous filler (B).

As the fibrous filler (B), it is possible to include, for example, one or more fibers selected from a metallic fiber, a natural fiber such as a wood fiber, cotton, hemp, or wool; a recycled fiber such as a rayon fiber; a semisynthetic fiber such as a cellulose fiber; a synthetic fiber such as a polyamide fiber, an aramid fiber, a polyimide fiber, a polyvinylalcohol fiber, a polyester fiber, an acrylic fiber, a polyparaphenylene benzoxazole fiber, a polyethylene fiber, a polypropylene fiber, a polyacrylonitrile fiber, or an ethylene vinyl alcohol fiber; a carbon fiber; and an inorganic fiber such as a glass fiber or a ceramic fiber. Among these, one or more of a synthetic fiber, a carbon fiber, and an inorganic fiber are more preferably included from the viewpoint of improving mechanical characteristics. A carbon fiber is particularly preferably included from the viewpoint of improving, particularly, bending strength. In addition, an aramid fiber is particularly preferably included from the viewpoint of improving impact resistance. One or more of a carbon fiber and an inorganic fiber are more preferably included and a carbon fiber is particularly preferably included from the viewpoint of improving thermal characteristics. In the present embodiment, it is possible to employ the fibrous filler (B) including both a carbon fiber and an aramid fiber as an example of a preferred aspect from the viewpoint of improving the balance between mechanical characteristics and thermal characteristics. A metal fiber is more preferably included from the viewpoint of improving electromagnetic wave-shielding performance.

The metallic fiber may be a metallic fiber constituted of a single metallic element or an alloy fiber constituted of multiple metals. As the metallic fiber, for example, one or more metallic elements selected from the group consisting of aluminum, silver, copper, magnesium, iron, chromium, nickel, titanium, zinc, tin, molybdenum, and tungsten are preferably included. Meanwhile, as the metallic fiber in the present embodiment, for example, stainless steel fibers manufactured by Nippon Seisen Co., Ltd. or Bekaert Corporation, copper fibers, aluminum fibers, brass fibers, steel fibers, titanium fibers, and phosphor bronze fibers manufactured by Kogi Corporation, and the like can be procured as commercially available products, but the metallic fiber is not limited thereto. These metallic fibers may be used singly or two or more metallic fibers may be jointly used. In addition, among these, any one or more of a copper fiber, an aluminum fiber, and a brass fiber are preferred from the viewpoint of heat-conducting properties, and any one or more of a stainless steel fiber, a copper fiber, and an aluminum fiber is preferred from the viewpoint of electromagnetic wave-shielding properties.

As the fibrous filler (B), a fibrous filler that has been surface-treated with a silane coupling agent, an aluminate coupling agent, a titanate coupling agent, or the like depending on required characteristics or a fibrous filler that has been treated with a convergence agent in order to improve adhesiveness to resins or handling properties may be used.

The fibrous filler (B) includes a fibrous filler (B1) having a fiber length of equal to or longer than 15 mm and equal to or shorter than 100 mm. Therefore, it is possible to improve the balance among the mechanical characteristics, thermal characteristics, electromagnetic wave-shielding performance, and the like of layers formed using the resin sheet.

In order to improve the uniformity of the density of the fibrous filler in the resin sheet, it is possible to employ a method for manufacturing the resin sheet formed by the papermaking method using both the binder resin and the fibrous filler as described above. Thus far, it has been realistic to use a fibrous filler having a relatively short fiber length of, for example, 6 mm in order to guarantee the uniformity of the density of the fibrous filler in the resin sheet that is formed using the papermaking method.

The present inventors studied regarding the addition of a fibrous filler which is a long fiber to resin sheets in order to improve the mechanical characteristics, thermal characteristics, electromagnetic wave-shielding performance, and the like of layers formed using the above-described resin sheets. However, in a case in which paper was made using a fibrous filler which was a long fiber of equal to or longer than 15 mm together with a binder resin, there was a concern that it may become difficult to realize sufficient mechanical characteristics or thermal characteristics. The reason is assumed that, for example, the density of the fibrous filler in the resin sheet does not become uniform due to the occurrence of clamping caused by entanglement between the fibrous filler segments which are long fibers, it becomes difficult to favorably carry out a dispersion treatment of the fibrous filler and the binder resin due to the entanglement of the fibrous filler which is a long fiber with rotary blades, or the like. Regarding specific means or examples for solving what has been described above, no techniques have been found in the related art. Therefore, it has become difficult to manufacture resin sheets by papermaking using both a binder resin and a fibrous filler which is a long fiber.

As a result of intensive studies, the present inventors found that a fibrous filler which is a long fiber can be uniformly dispersed in the resin sheet which is formed using the papermaking method by respectively adjusting the method for manufacturing the resin sheet, the kinds or blending fractions of constituent materials in the resin sheet, and the like and realized the resin sheet according to the present embodiment. For example, stirring of constituent materials including the binder resin and the fibrous filler by rotating blades at a high speed, inclusion of pulp together with the binder resin and the fibrous filler as the constituent materials, appropriate adjustment of the blending fractions of the respective constituent materials, and the like are considered as important elements for improving the uniformity of the density of the long fibrous filler. In the present embodiment, when the above-described adjustment is highly accurately carried out, it becomes possible to realize a resin sheet including a binder resin and a fibrous filler having a fiber length of equal to or longer than 15 mm and equal to or shorter than 100 mm using the papermaking method.

From the viewpoint of improving the mechanical characteristics, particularly, impact resistance of layers formed using the resin sheet, the fiber length of the fibrous filler (B1) is particularly preferably equal to or longer than 25 mm. In addition, from the viewpoint of more effectively improving the balance between mechanical characteristics and thermal characteristics by improving the dispersibility of the fibrous filler (B1), the fiber length of the fibrous filler (B1) is particularly preferably equal to or shorter than 90 mm.

The content of the fibrous filler (B1) is, for example, preferably equal to or more than 10% by weight, more preferably equal to or more than 30% by weight, and particularly preferably equal to or more than 60% by weight of the entire fibrous filler (B). In such a case, it is possible to more effectively improve the balance between mechanical characteristics and thermal characteristics in layers formed using the resin sheet. Meanwhile, the upper limit value of the content of the fibrous filler (B1) is not particularly limited and can be set to, for example, 100% by weight of the entire fibrous filler (B). In the present embodiment, the fibrous filler (B1) including a carbon fiber can be employed as an example of a preferred aspect.

The fibrous filler (B) may include, for example, a fibrous filler (B2) having a fiber length of shorter than 15 mm together with the fibrous filler (B1). In such a case, it becomes easier to control the balance among the mechanical characteristics, thermal characteristics, electromagnetic wave-shielding performance, and the like of layers formed using the resin sheet. The lower limit value of the fiber length of the fibrous filler (B2) is not particularly limited and can be set to, for example, 1 mm. Meanwhile, the fibrous filler (B) may not include the fibrous filler (B2).

In addition, the fibrous filler (B) may include, for example, a fibrous filler (B3) having a fiber length of longer than 100 mm together with the fibrous filler (B1). In such a case, it becomes easier to control the balance among the mechanical characteristics, thermal characteristics, electromagnetic wave-shielding performance, and the like of layers formed using the resin sheet. The upper limit value of the fiber length of the fibrous filler (B3) is not particularly limited and can be set to, for example, 200 mm. Meanwhile, the fibrous filler (B) may not include the fibrous filler (B3).

The diameter of the fibrous filler (B) is, for example, preferably equal to or longer than 1 μm and more preferably equal to or longer than 5 μm. In such a case, it is possible to improve the stiffness of layers formed using the resin sheet. On the other hand, the diameter of the fibrous filler (B) is, for example, preferably equal to or shorter than 100 μm and more preferably equal to or shorter than 80 μm. In such a case, it is possible to ensure the molding workability of the resin sheet. Meanwhile, the fiber length and diameter of the fibrous filler (B) can be confirmed by, for example, observing the obtained resin sheet or the fibrous filler (B) extracted from the resin sheet by dissolving the resin component using an electron microscope.

The content of the fibrous filler (B) is preferably equal to or more than 15% by weight, more preferably equal to or more than 25% by weight, and particularly preferably equal to or more than 30% by weight of the entire resin sheet. In such a case, it is possible to more effectively improve the balance between mechanical characteristics or thermal characteristics and electromagnetic wave-shielding properties in layers formed using the resin sheet. Meanwhile, the content of the fibrous filler (B) is preferably equal to or less than 80% by weight, more preferably equal to or less than 70% by weight, and particularly preferably equal to or less than 60% by weight of the entire resin sheet. In such a case, it is possible to improve the workability or lightweight properties of the resin sheet. In addition, it is also possible to more effectively improve the dispersibility of the fibrous filler (B), thereby contributing to the improvement in the mechanical characteristics or thermal characteristics and electromagnetic wave-shielding properties of layers formed using the resin sheet.

((C) Pulp)

The pulp (C) is a fiber material having a fibrillar structure and can be obtained by, for example, mechanically or chemically turning a fiber material into fibrils. In a method for manufacturing the resin sheet using the papermaking method described below, the binder resin (A) can be sufficiently agglomerated by papermaking using the pulp (C) together with the binder resin (A) and the fibrous filler (B), and thus it becomes possible to realize stable manufacturing of the resin sheet. In addition, since it is also possible to improve the dispersibilty of the fibrous filler (B1) which is a long fiber, it is also possible to contribute to the improvement in the mechanical characteristics or thermal characteristics of layers formed using the resin sheet.

Examples of the pulp (C) include fibrils of a cellulose fiber such as linter pulp or wood pulp, a natural fiber such as kenaf, jute, or bamboo, or an organic fiber such as a para-type wholly aromatic polyamide fiber (aramid fiber) or a copolymer thereof, an aromatic polyester fiber, a polybenzazole fiber, a meta-type aramid fiber or a copolymer thereof, an acrylic fiber, an acrylonitrile fiber, a polyimide fiber, or a polyamide fiber. The pulp (C) may include one or more of the above-described fibrils. Among these, from the viewpoint of improving the mechanical characteristics or thermal characteristics of layers formed using the resin sheet or improving the dispersibility of the fibrous filler (B1) which is a long fiber, either or both aramid pulp constituted of an aramid fiber and polyacrylonitrile pulp constituted of an acrylonitrile fiber are particularly preferably included.

The content of the pulp (C) is preferably equal to or more than 5% by weight, more preferably equal to or more than 8% by weight, and particularly preferably equal to or more than 10% by weight of the entire resin sheet. In such a case, it is possible to more effectively agglomerate the binder resin (A) during papermaking and thus realize more stable manufacturing of the resin sheet. In addition, it also becomes possible to more effectively improve the dispersibilty of the fibrous filler (B1). On the other hand, the content of the pulp (C) is preferably equal to or lower than 25% by weight, more preferably equal to or lower than 22% by weight, and particularly preferably equal to or lower than 20% by weight of the entire resin sheet. In such a case, it becomes possible to more effectively improve the mechanical characteristics or thermal characteristics.

((D) Agglomerating Agent)

The resin sheet may include, for example, an agglomerating agent (D). The agglomerating agent (D) has a function of agglomerating the binder resin (A) and the fibrous filler (B) in a flock pattern in the method for manufacturing the resin sheet using the papermaking method described below. Therefore, it is possible to realize more stable manufacturing of the resin sheet.

As the agglomerating agent (D), for example, one or more selected from cationic polymer agglomerating agents, anionic polymer agglomerating agents, nonionic polymer agglomerating agents, and amphoteric polymer agglomerating agents may be included. Examples of the above-described agglomerating agent (D) include cationic polyacrylamides, anionic polyacrylamides, Hoffman polyacrylamides, Man Nick polyacrylamides, amphoteric copolymer polyacrylamides, cationized starch, amphoteric starch, polyethylene oxides, and the like. In addition, in the agglomerating agent (D), the polymer structure or molecular weight thereof, the amount of a functional group such as a hydroxyl group or an ionic group, and the like can be adjusted depending on required characteristics without any particular limitations.

The content of the agglomerating agent (D) is preferably equal to or higher than 0.05% by weight, more preferably equal to or higher than 0.1% by weight, and particularly preferably equal to or higher than 0.2% by weight of the entire resin sheet. In such a case, in the manufacturing of the resin sheet using the papermaking method, it is possible to improve the yield. On the other hand, the content of the agglomerating agent (D) is preferably equal to or lower than 3% by weight, more preferably equal to or lower than 2% by weight, and particularly preferably equal to or lower than 1.5% by weight of the entire resin sheet. In such a case, in the manufacturing of the resin sheet using the papermaking method, it becomes possible to more easily and stably carry out a dewatering treatment or the like.

The resin sheet may include, for example, a powder-form substance having an ion exchange function in addition to the respective components described above. As the powder-form substance having an ion exchange function, for example, one or more intercalation compounds selected from clay minerals, scale-like silica fine particles, hydrotalcites, fluorine taeniolite, and lubricating synthetic mica are preferably used. Examples of the clay minerals include smectite, halloysite, kanemite, kenyaite, zirconium phosphate, titanium phosphate, and the like. Examples of the hydrotalcites include hydrotalcite and hydrotalcite-like substances. Examples of the fluorine taeniolite include lithium-type fluorine taeniolite, sodium-type fluorine taeniolite, and the like. Examples of the lubricating synthetic mica include sodium-type tetrasilicon fluorine mica, lithium-type tetrasilicon fluorine mica, and the like. These intercalation compounds may be natural substances or synthesized substances. Among these, clay minerals are more preferred, and smectite is more preferred since smectite is present not only in a natural substance form but also in a synthetic substance form and can be selected from a broad range. Examples of smectite include montmorillonite, beidellite, nontronite, saponite, hectorite, sauconite, stevensite, and the like, and any one or more out of the above-described smectite can be used. Montmorillonite is a hydrous silicate of aluminum, but may be bentonite including montmorillonite as a main component and, additionally, minerals such as silica, mica, feldspar, and zeolites. In a case in which coloration and impurities are concerned during the use of the resin sheet, synthetic smectite including only a small number of impurities is preferred.

In addition, the resin sheet may include, for example, one or more selected from additives such as inorganic powder intended to improve characteristics, metal powder, a stabilizer such as an antioxidant or an ultraviolet absorber, a mold release agent, a plasticizer, a flame retardant, a curing catalyst or curing accelerator for resins, a pigment, a paper strength enhancer such as a dry paper strength enhancer or a wet paper strength enhancer, an yield improver, a drainage aid, a size fixing agent, an anti-foaming agent, a sizing agent such as a rosin-based sizing agent for acidic papermaking, a rosin-based sizing agent for neutral paper production, an alkylketene dimer-based sizing agent, an alkenylsuccinic anhydride-based sizing agent, or a special modified rosin-based sizing agent, and a condensing agent such as aluminum sulfate, aluminum chloride, or poly aluminum chloride for the purpose of adjusting production conditions or developing required properties. Examples of the inorganic powder include oxides such as titanium oxide, alumina, silica, zirconia, and magnesium oxide, nitrides such as boron nitride, aluminum nitride, and silicon nitride, sulfides such as barium sulfate, iron sulfate, and copper sulfate, hydroxides such as aluminum hydroxide and magnesium hydroxide, minerals such as kaolinite, talc, natural mica, and synthetic mica, carbides such as silicon carbide, and the like. The inorganic powder may be used as it is, but may also be used after being surface-treated with a silane coupling agent, an aluminate coupling agent, a titanate coupling agent, or the like depending on required characteristics.

Next, a method for manufacturing the resin sheet will be described.

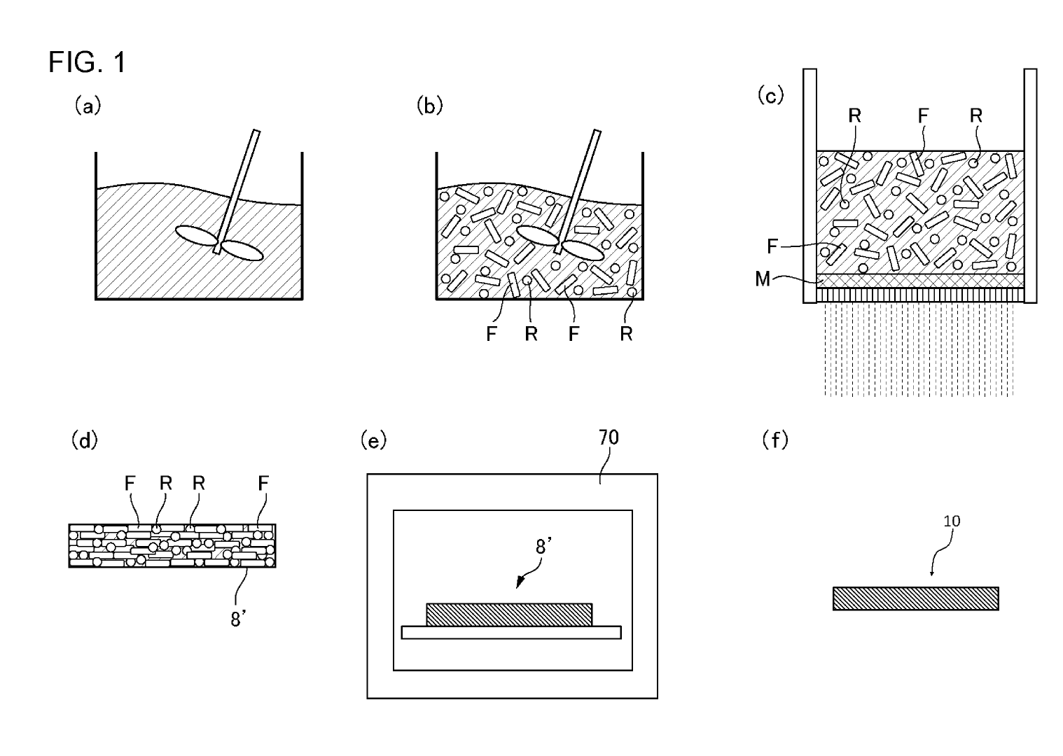

FIG. 1 is a cross-sectional diagram illustrating a method for manufacturing a resin sheet 10 according to the present embodiment. The resin sheet 10 is manufactured using, for example, a wet-type papermaking method. The method for manufacturing the resin sheet 10 according to the present embodiment includes a step of papermaking using a material composition including, for example, a binder resin, a fibrous filler having a fiber length of equal to or longer than 15 mm and equal to or shorter than 100 mm, and pulp.

Hereinafter, an example of the method for manufacturing the resin sheet 10 will be described in detail.

First, as illustrated in FIGS. 1(a) and 1(b), the respective components described above except for the agglomerating agent (D) are added to a solvent and are dispersed by means of stirring. Here, the binder resin (A), the fibrous filler (B), the pulp (C), and, if necessary, other additives are added to a solvent and are dispersed by means of stirring. Therefore, it is possible to obtain a varnish-form material composition for forming the resin sheet. Meanwhile, in FIG. 1, the reference sign R represents the binder resin (A), and the reference sign F represents the fibrous filler (B), respectively.

A method for dispersing the respective components in a solvent is not particularly limited, and examples thereof include a method in which the components are stirred using a disperser. At this time, when the disperser is rotated under a high-speed condition of, for example, approximately 5,000 rpm, it becomes possible to suppress the occurrence of clamping caused by entanglement of the fibrous filler (B1), entanglement of the fibrous filler (B1) with stirring blades, or the like even in a case in which the fibrous filler (B1) which is a long fiber is used. Stirring conditions other than the rotation speed such as stirring duration can also be appropriately adjusted if necessary.

The solvent is not particularly limited, but a solvent having a boiling point of equal to or higher than 50° C. and equal to or lower than 200° C. is preferred since the solvent is not easily volatilized in a process for dispersing the constituent materials of the material composition, it is easy to carry out desolvation for suppressing the solvent remaining in the resin sheet, an increase in energy due to desolvation is suppressed, and the like. Examples of the above-described solvent include water, alcohols such as ethanol, 1-propanol, 1-butanol, and ethylene glycol, ketones such as acetone, methyl ethyl ketone, 2-heptanone, and cyclohexanone, esters such as ethyl acetate, butyl acetate, methyl acetoacetate, and methyl acetoacetate, ethers such as tetrahydrofuran, isopropyl ether, dioxane, and furfural, and the like. These solvents may be used singly or two or more solvents may be jointly used. Among these, water is particularly preferably used since water has an abundant supply amount, an inexpensive price, and a low environmental load and is also highly safe and can be easily handled.

In the above-described step of obtaining the varnish-form material composition, as the binder resin (A), it is possible to use, for example, a solid-state binder resin having an average particle diameter of equal to or smaller than 500 μm. In addition, as the binder resin (A), for example, an emulsion-form binder resin having an average particle diameter of equal to or smaller than 500 μm can also be used. In such a case, it is possible to further facilitate the formation of an agglomerated state in a step of agglomerating the binder resin (A) which will be described below. In the above-described step of obtaining the varnish-form material composition, the average particle diameter of the binder resin (A) is more preferably equal to or larger than 1 nm and equal to or smaller than 300 μm. The binder resin (A) having the above-described average particle diameter can be obtained by carrying out a crushing treatment using, for example, an atomizer crusher or the like. Meanwhile, the average particle diameter of the binder resin (A) can be obtained by measuring the particle diameter of a particle having the 50% mass as the average particle diameter using, for example, a laser diffraction-type particle size distribution analyzer such as SALD-7000 manufactured by Shimadzu Corporation.

Next, the agglomerating agent (D) is added to the varnish-form material composition obtained above. Therefore, it is possible to obtain an agglomerated substance by agglomerating the binder resin (A), the fibrous filler (B), and the pulp (C) in a flock pattern in the solvent.

Next, as illustrated in FIG. 1(c), a solvent and the agglomerated substance obtained above are put into a container having a bottom surface constituted of meshes M, and the solvent is discharged through the meshes M. Therefore, the agglomerated substance and the solvent can be separated from each other. At this time, an agglomerated substance 8′ having a sheet shape as illustrated in FIG. 1(d) remains on the meshes M. In the present embodiment, it is possible to adjust the shape of a resin sheet to be obtained by appropriately selecting the shape of the mesh M.

Next, as illustrated in FIG. 1(e), the sheet-shaped agglomerated substance 8′ obtained above is taken out, is put into a drying furnace 70, and is dried, thereby further removing moisture. In the present embodiment, a resin sheet 10 as illustrated in FIG. 1(f) is manufactured, for example, in the above-described manner.

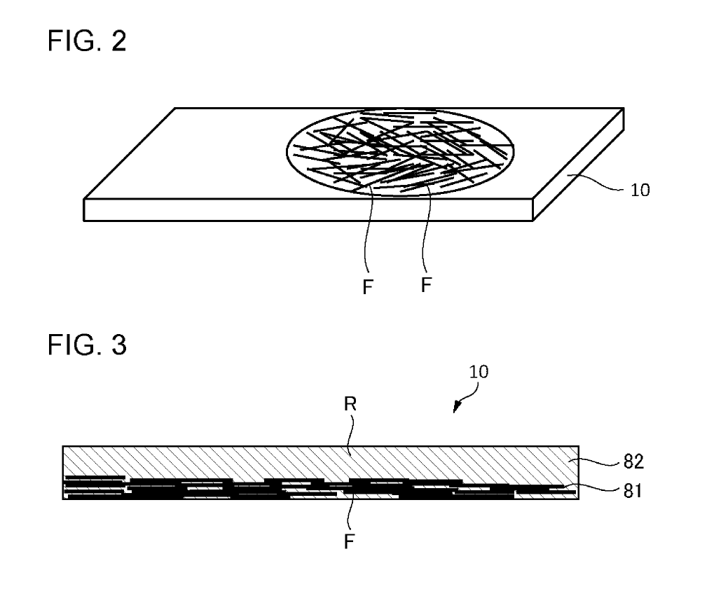

FIG. 2 is a perspective diagram illustrating an example of the resin sheet 10 manufactured using the papermaking method.

As illustrated in FIG. 2, in the resin sheet 10 manufactured using the papermaking method, a majority of the fibrous filler (B) is disposed so that, for example, the longitudinal direction of the fibrous filler (B) is along the in-plane direction of the resin sheet 10. On the other hand, as illustrated by a portion surrounded by a circle in FIG. 2, in a case in which the resin sheet 10 is seen in a plan view, segments of the fibrous filler (B) are randomly distributed and are entangled with each other in the plane of the resin sheet 10. Therefore, for example, in a case in which the fibrous filler (B) is constituted of a thermally conductive material having strong heat-conducting properties, it is possible to make the thermal conductivity extremely high in the in-plane direction of the resin sheet 10. For example, the thermal conductivity of the resin sheet 10 in the in-plane direction can be set to ten or more times the thermal conductivity in the thickness direction. In addition, the binder resin (A) is interposed between segments of the fibrous filler (B), and the segments of the fibrous filler (B) are bonded to each other. In FIG. 2, the reference sign F represents the fibrous filler (B). In addition, in FIG. 2, the fibrous filler (B) located outside the portion surrounded by the circle is not illustrated.

FIG. 3 is a cross-sectional diagram illustrating an example of the resin sheet 10 manufactured using the papermaking method.

In a case in which the resin sheet 10 is manufactured using the papermaking method, in the step of separating the solvent and the agglomerated substance by discharging the solvent through the meshes, there are cases in which the fibrous filler (B) moves toward the meshes due to its weight. In this case, although also depending on the content of the binder resin (A), the kind of the fibrous filler (B), or the like, there are cases in which the distance from the central location in the thickness direction of a fiber layer 81 including a large amount of the fibrous filler (B) to one surface (front surface) of the resin sheet 10 which is located on the side of a resin layer 82 including a large amount of the binder resin (A) and the distance from the central location to the other surface (rear surface) become different from each other as illustrated in FIG. 3. Meanwhile, in FIG. 3, the reference sign R represents the binder resin (A), and the reference sign F represents the fibrous filler (B), respectively.

In addition, although also depending on the content of the binder resin (A), the kind of the fibrous filler (B), or the like in the resin sheet 10, multiple voids may be formed in the resin sheet 10. In such a case, it is possible to reduce the weight of the resin sheet 10.

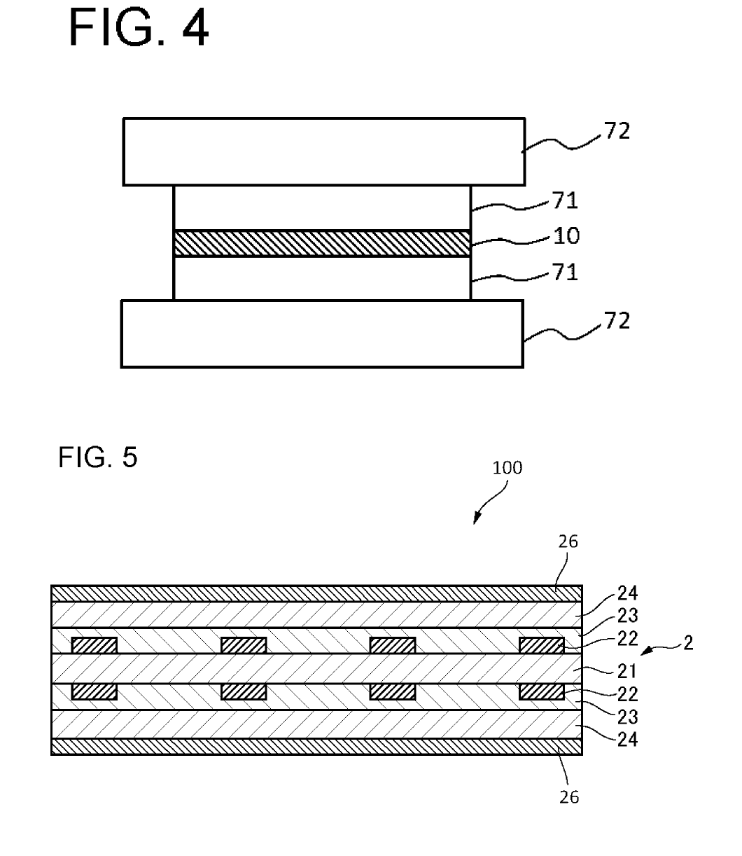

FIG. 4 is a cross-sectional diagram illustrating a method for forming a compact using the resin sheet 10.

In the present embodiment, a compact constituting a variety of articles can be formed by, for example, molding the manufactured resin sheet 10. Examples of a molding method include press molding and the like. As illustrated in FIG. 4, the resin sheet 10 is pressed using pressing plates 71, hot plates 72 are disposed on the outer circumferential side of the pressing plates 71, and the resin sheet is heated. Therefore, a compact constituting an article can be obtained. Meanwhile, in a case in which a thermosetting resin is included in the resin sheet 10 as the binder resin (A), the thermosetting resin is preferably in a semi-cured state in the compact obtained by means of the above-described steps. In such a case, it is possible to laminate the compact on another member and then thermally cure the compact, and thus the compact and other members can be more strongly fixed to each other.

The bending strength of the compact formed using the resin sheet is, for example, preferably equal to or more than 310 MPa and more preferably equal to or more than 350 MPa. In such a case, it is possible to realize high-strength compacts. Therefore, it also becomes possible to contribute to improvement in the reliability of articles including the compact. Meanwhile, the bending strength can be measured using, for example, a three-point bending testing method according to JIS K 6911.

The Charpy impact value of the compact formed using the resin sheet, which is measured by means of a Charpy impact test, is, for example, preferably equal to or more than 15 kJ/m² and more preferably equal to or more than 25 kJ/m². In such a case, it is possible to realize compacts having excellent impact resistance. Therefore, it also becomes possible to contribute to improvement in the reliability of articles including the compact. Meanwhile, the Charpy impact test can be carried out according to, for example, JIS K 7110.

The thermal conductivity in the planar direction of the compact formed using the resin sheet is, for example, preferably equal to or more than 1.5 W/mK, more preferably equal to or more than 2.0 W/mK, and particularly preferably equal to or more than 2.2 W/mK. In such a case, it becomes possible to realize favorable thermal characteristics. Therefore, it also becomes possible to contribute to improvement in the reliability of articles including the compact. The thermal conductivity can be measured using, for example, a laser flash method.

Meanwhile, the bending strength, Charpy impact value, and thermal conductivity of the compact formed using the resin sheet can be controlled by respectively adjusting the method for manufacturing the resin sheet, the kinds or blending fractions of the constituting materials in the resin sheet, and the like.

(Article)

Next, an article will be described.

The article includes a layer formed of the resin sheet according to the present embodiment. Therefore, it is possible to realize articles having excellent reliability. The layer is constituted of, for example, a compact obtained by molding the resin sheet. The article in the present embodiment is not particularly limited, and examples thereof include flexible wiring substrates, interposer substrates, substrates constituting electronic components such as component-embedded substrates and optical waveguide substrates, chasses of electronic devices, and the like.

FIG. 5 is a cross-sectional diagram illustrating an example of an article 100 according to the present embodiment.

FIG. 5 illustrates a case in which the article 100 is a flexible wiring substrate. The article according to the example illustrated in FIG. 5 includes, for example, a substrate 2 and layers 26 formed of the resin sheet 10 provided on the substrate 2. The substrate 2 includes a resin film 21, circuit layers 22 provided on the front and rear surfaces of the resin film 21, coverlay films 24 that cover the respective circuit layers 22, and adhesive layers 23 provided between the coverlayer film 24 and the circuit layer 22. In addition, the layers 26 formed of the resin sheet 10 are provided on the respective coverlay films 24. The resin film 21 is, for example, a polyimide film. The adhesive layer 23 is, for example, an epoxy-based adhesive. The circuit layer 22 is, for example, a copper circuit. The coverlay film 24 is, for example, a polyimide film or a polyester film.

As a method for attaching the resin sheet 10 to the substrate 2, there are a variety of methods, and it is possible to employ, for example, a method for attaching the resin sheet 10 to the substrate 2 through an adhesive. In addition, the resin sheet 10 is attached to the substrate 2 by pressing the resin sheet 10 in a semi-cured state on the substrate 2 and then heating the substrate 2 and the resin sheet 10. In this case, for example, the resin sheet 10 is heated and cured, thereby forming a state in which the resin sheet is fixed to the substrate 2. In addition, according to this method, the resin sheet 10 is brought into direct contact with the substrate 2.

Meanwhile, the present invention is not limited to the above-described embodiment, and modification, improvement, and the like may be considered to be within the scope of the present invention as long as the object of the present invention can be achieved.

### EXAMPLES

Next, examples of the present invention will be described.

(Manufacturing of Resin Sheet)

In individual examples and individual comparative examples, resin sheets were manufactured as described below.

First, the binder resin (A) which had been crushed to an average particle diameter of 100 μm using an atomizer crusher, the fibrous filler (B), and the pulp (C) were added to 10,000 parts of water according to the formulations shown in Tables 1 and 2 and were stirred for 20 minutes under a condition of 5,000 rpm using a disperser, thereby obtaining a mixture. Next, 0.5% of the agglomerating agent (D) of the total of the above-described constituent materials (the binder resin (A), the fibrous filler (B), and the pulp (C)) which had been dissolved in water in advance was added thereto, and the constituent materials were agglomerated in a flock pattern. Therefore, the agglomerated substance obtained in the above-described manner was separated from water using a metal net having 40 meshes, then, the agglomerated substance was pressed under dewatering and, furthermore, was put into a dryer (70° C.) for three hours so as to be dried, thereby obtaining a resin sheet constituted of a 1 mm-thick composite resin composition.

The details of the respective components shown in Tables 1 and 2 are as described below.

(A) Binder Resin

Resol resin: manufactured by Sumitomo Bakelite Co., Ltd., PR-51723

Epoxy resin: a mixture of 99% of 828 (manufactured by Mitsubishi Chemical Corporation) and 1% of 2-methylimidazole

Polypropylene resin: manufactured by Tokyo Printing Ink Mfg. Co., Ltd.

(B) Fibrous Filler

Fibrous filler 1: a carbon fiber (having a fiber length of 120 mm)

Fibrous filler 2: a carbon fiber (having a fiber length of 85 mm)

Fibrous filler 3: a carbon fiber (having a fiber length of 50 mm)

Fibrous filler 4: a carbon fiber (having a fiber length of 35 mm)

Fibrous filler 5: a carbon fiber (having a fiber length of 25 mm) Fibrous filler 6: a carbon fiber (having a fiber length of 6 mm)

Fibrous filler 7: an aramid fiber (TECHNOLA T-32PNW (manufactured by Teijin Limited.), having a fiber length of 3 mm)

Meanwhile, as the fibrous fillers 1 to 6, fillers obtained by cutting HTS40 (having a diameter of 7 μm) manufactured by Toho Tenax Co., Ltd. to a predetermined length were used.

(C) Pulp

Aramid pulp: KEVLAR pulp 1F303 (manufactured by Du Pont-Toray Co., Ltd.)

Polyacrylonitrile pulp: XPUL (manufactured by Toyobo Co., Ltd.)

(D) Agglomerating Agent

Polyethylene oxide: manufactured by Sumitomo Seika Chemicals Co., Ltd.

Cationized starch: SC-5 (manufactured by Sanwa Starch Co., Ltd.)

Meanwhile, in Comparative Examples 3 and 4, it was not possible to obtain resin sheets. This is considered to be because the trapping force of the fibrous filler (B) could not be sufficiently obtained due to the absence of the pulp (C) and, consequently, the binder resin (A) could not be sufficiently agglomerated.

(Compact)

In Examples 1 to 13 and Comparative Examples 1 and 2, compacts were manufactured as described below.

First, four resin sheets constituted of the composite resin composition obtained above which had been cut to 10 cm×10 cm were laminated together and then were thermally treated for ten minutes under conditions of a pressure of 300 kg/cm² and a temperature of 180° C., thereby obtaining a 10 cm×10 cm×1 mm compact.

(Bending Strength)

In Examples 1 to 13 and Comparative Examples 1 and 2, the bending strengths of the compacts obtained above were measured. The bending strengths were measured using a three-point bending testing method according to JIS K 6911. As a test specimen, a 2.5 cm×5 cm specimen cut out from the compact was used. The results are shown in Tables 1 and 2. The unit of the bending strengths in Tables 1 and 2 are MPa.

(Charpy Impact Test)

In Examples 1 to 13 and Comparative Examples 1 and 2, Charpy impact tests were carried out on the compacts obtained above. The tests were carried out according to JIS K 7110. As a test specimen, an 8 cm×4 mm specimen cut out from the compact was used. The results are shown in Tables 1 and 2. The unit of the Charpy impact values in Tables 1 and 2 are kJ/m².

(Thermal Conductivity)

In Examples 1 to 13 and Comparative Examples 1 and 2, the thermal conductivities of the compacts obtained above were measured. The thermal conductivities were measured by measuring the thermal conductivities in the planar direction of thermal conductive layers using a laser flash method in 10 mm×10 mm×1 mm test specimens cut out from the compacts. The results are shown in Tables 1 and 2. The unit of the thermal conductivities in Tables 1 and 2 are W/mK.

TABLE 1

| | | Example 1 | Example 2 | Example 3 | Example 4 | Example 5 |
|---|---|---|---|---|---|---|
| Binder resin | Resol resin | 48 (48) | 48 (48) | 48 (48) | 53 (53) | 53 (53) |
| (A) | Epoxy resin | | | | | |
| | Polypropylene | | | | | |
| | resin | | | | | |
| Fibrous filler | Fibrous filler 1 | | | | | |
| (B) | (having a fiber | | | | | |
| | length of 120 mm) | | | | | |
| | Fibrous filler 2 | | | | 32 (32) | |
| | (having a fiber | | | | | |
| | length of 85 mm) | | | | | |
| | Fibrous filler 3 | 37 (37) | | | | 32 (32) |
| | (having a fiber | | | | | |
| | length of 50 mm) | | | | | |
| | Fibrous filler 4 | | 37 (37) | | | |
| | (having a fiber | | | | | |
| | length of 35 mm) | | | | | |
| | Fibrous filler 5 | | | 37 (37) | | |
| | (having a fiber | | | | | |
| | length of 25 mm) | | | | | |
| | Fibrous filler 6 | | | | | |
| | (having a fiber | | | | | |
| | length of 6 mm) | | | | | |
| | Fibrous filler 7 | | | | | |
| | (having a fiber | | | | | |
| | length of 3 mm) | | | | | |
| Pulp (C) | Aramid pulp | 15 (15) | 15 (15) | 15 (15) | 15 (15) | 15 (15) |
| | Polyacrylonitrile | | | | | |
| | pulp | | | | | |
| Agglomerating | Polyethylene oxide | 0.5 (0.50) | 0.5 (0.50) | 0.5 (0.50) | 0.5 (0.50) | 0.5 (0.50) |
| agent (D) | Cationized starch | | | | | |

| | | | | | |
|---|---|---|---|---|---|
| Bending strength (MPa) | 440 | 420 | 400 | 440 | 400 |
| Charpy impact value (kJ/m²) | 32 | 30 | 27 | 33 | 30 |
| Thermal conductivity (W/mK) | 3 | 3 | 3 | 2.8 | 2.8 |

| | | Example 6 | Example 7 | Example 8 | Example 9 |
|---|---|---|---|---|---|
| Binder resin | Resol resin | 48 (48) | 50 (50) | | |
| (A) | Epoxy resin | | | 48 (48) | |
| | Polypropylene | | | | 48 (48) |
| | resin | | | | |
| Fibrous filler | Fibrous filler 1 | | | | |
| (B) | (having a fiber | | | | |
| | length of 120 mm) | | | | |
| | Fibrous filler 2 | | | | |
| | (having a fiber | | | | |
| | length of 85 mm) | | | | |
| | Fibrous filler 3 | 32 (32) | 20 (20) | 37 (37) | 37 (37) |
| | (having a fiber | | | | |
| | length of 50 mm) | | | | |
| | Fibrous filler 4 | | | | |
| | (having a fiber | | | | |
| | length of 35 mm) | | | | |
| | Fibrous filler 5 | | | | |
| | (having a fiber | | | | |
| | length of 25 mm) | | | | |
| | Fibrous filler 6 | | | | |
| | (having a fiber | | | | |
| | length of 6 mm) | | | | |
| | Fibrous filler 7 | 5 (5) | 15 (15) | | |
| | (having a fiber | | | | |
| | length of 3 mm) | | | | |
| Pulp (C) | Aramid pulp | 15 (15) | 15 (15) | 15 (15) | 15 (15) |
| | Polyacrylonitrile | | | | |
| | pulp | | | | |
| Agglomerating | Polyethylene oxide | 0.5 (0.50) | 0.5 (0.50) | 0.5 (0.50) | 0.5 (0.50) |
| agent (D) | Cationized starch | | | | |

| | | | | |
|---|---|---|---|---|
| Bending strength (MPa) | 400 | 390 | 440 | 330 |
| Charpy impact value (kJ/m²) | 40 | 45 | 32 | 35 |
| Thermal conductivity (W/mK) | 2.5 | 2 | 3 | 3 |

TABLE 2

| | | Example | Example | Example | Example | Comparative |
|---|---|---|---|---|---|---|
| | | 10 | 11 | 12 | 13 | Example 1 |
| Binder resin | Resol resin | 48 (48) | 48 (48) | 53 (53) | 43 (43) | 48 (48) |
| (A) | Epoxy resin | | | | | |
| | Polypropylene resin | | | | | |
| Fibrous filler | Fibrous filler 1 | | | | | 37 (37) |
| (B) | (having a fiber | | | | | |
| | length of 120 mm) | | | | | |
| | Fibrous filler 2 | | | | | |
| | (having a fiber | | | | | |
| | length of 85 mm) | | | | | |
| | Fibrous filler 3 | 37 (37) | 37 (37) | 37 (37) | 37 (37) | |
| | (having a fiber | | | | | |
| | length of 50 mm) | | | | | |
| | Fibrous filler 4 | | | | | |
| | (having a fiber | | | | | |
| | length of 35 mm) | | | | | |
| | Fibrous filler 5 | | | | | |
| | (having a fiber | | | | | |
| | length of 25 mm) | | | | | |
| | Fibrous filler 6 | | | | | |
| | (having a fiber | | | | | |
| | length of 6 mm) | | | | | |
| | Fibrous filler 7 | | | | | |
| | (having a fiber | | | | | |
| | length of 3 mm) | | | | | |
| Pulp (C) | Aramid pulp | | 15 (15) | 10 (10) | 20 (20) | 15 (15) |
| | Polyacrylonitrile | 15 (15) | | | | |
| | pulp | | | | | |
| Agglomerating | Polyethylene oxide | 0.5 (0.50) | | 0.5 (0.50) | 0.5 (0.50) | 0.5 (0.50) |
| agent (D) | Cationized starch | | 0.5 (0.50) | | | |

| | | | | | |
|---|---|---|---|---|---|
| Bending strength (MPa) | 440 | 440 | 440 | 440 | 280 |
| Charpy impact value (kJ/m²) | 32 | 32 | 30 | 35 | 22 |
| Thermal conductivity (W/mK) | 3 | 3 | 3 | 3 | 2 |

| | | Comparative | Comparative | Comparative |
|---|---|---|---|---|
| | | Example 2 | Example 3 | Example 4 |
| Binder resin | Resol resin | 48 (48) | 63 (63) | 48 (48) |
| (A) | Epoxy resin | | | |
| | Polypropylene resin | | | |
| Fibrous filler | Fibrous filler 1 | | | |
| (B) | (having a fiber | | | |
| | length of 120 mm) | | | |
| | Fibrous filler 2 | | | |
| | (having a fiber | | | |
| | length of 85 mm) | | | |
| | Fibrous filler 3 | | 37 (37) | 37 (37) |
| | (having a fiber | | | |
| | length of 50 mm) | | | |
| | Fibrous filler 4 | | | |
| | (having a fiber | | | |
| | length of 35 mm) | | | |
| | Fibrous filler 5 | | | |
| | (having a fiber | | | |
| | length of 25 mm) | | | |
| | Fibrous filler 6 | 37 (37) | | |
| | (having a fiber | | | |
| | length of 6 mm) | | | |
| | Fibrous filler 7 | | | 15 (15) |
| | (having a fiber | | | |
| | length of 3 mm) | | | |
| Pulp (C) | Aramid pulp | 15 (15) | | |
| | Polyacrylonitrile | | | |
| | pulp | | | |
| Agglomerating | Polyethylene oxide | 0.5 (0.50) | 0.5 (0.50) | 0.5 (0.50) |
| agent (D) | Cationized starch | | | |

| | | | |
|---|---|---|---|
| Bending strength (MPa) | 300 | Not moldable | Not moldable |
| Charpy impact value (kJ/m²) | 14 | Not moldable | Not moldable |
| Thermal conductivity (W/mK) | 2.8 | Not moldable | Not moldable |

Meanwhile, in Tables 1 and 2, regarding numerical values indicating the blending fractions of the respective components, numerical values outside parentheses have a unit of ‘parts by weight’, and numerical values in parentheses have a unit of ‘% by weight’.

The resin sheets according to Examples 1 to 13 included the binder resin (A), the fibrous filler (B), and the pulp (C). In addition, the fibrous filler (B) included a fibrous filler having a fiber length of equal to or longer than 15 mm and equal to or shorter than 100 mm. It is found from the results shown in Tables 1 and 2 that the compacts formed using the above-described resin sheet were excellent in terms of mechanical strength.

On the other hand, the resin sheets according to Comparative Examples 1 and 2 did not include a fibrous filler having a fiber length of equal to or longer than 15 mm and equal to or shorter than 100 mm as the fibrous filler (B). It is found that the compacts formed using the above-described resin sheet according to Comparative Examples 1 and 2 were poorer in terms of bending strength and impact resistance than those of the examples. In addition, in Comparative Examples 3 and 4, as described above, it was not possible to manufacture resin sheets.

This application claims priority on the basis of Japanese Patent Application No. 2014-111191, filed on May 29, 2014, and the content thereof is incorporated herein by reference.

1. A resin sheet comprising:
a binder resin;
a fibrous filler having a fiber length of equal to or longer than 15 mm and equal to or shorter than 100 mm; and
pulp.

2. The resin sheet according to claim 1,
wherein a content of the fibrous filler is equal to or more than 15% by mass and equal to or less than 80% by mass of the entire resin sheet.

3. The resin sheet according to claim 1,
wherein the fibrous filler includes a carbon fiber.

4. The resin sheet according to claim 1,
wherein a content of the pulp is equal to or higher than 5% by mass and equal to or lower than 25% by mass of the entire resin sheet.

5. The resin sheet according to claim 1,
wherein the resin sheet is composed of a papermaking product obtained by a papermaking method using a material composition including the binder resin, the fibrous filler, and the pulp.

6. An article comprising:
a layer formed of the resin sheet according to claim 1.

7. A method for manufacturing a resin sheet comprising:
a step of papermaking using a slurry including a binder resin, a fibrous filler having a fiber length of equal to or longer than 15 mm and equal to or shorter than 100 mm, and pulp.
